(19) United States
(12) Patent Application Publication
(10) Pub. No.: US 2022/0288810 A1
(43) Pub. Date: Sep. 15, 2022

(54) OUTDOOR CABINET

(71) Applicant: IDEAL CABINET OPERATIONS, LTD., Jupiter, FL (US)

(72) Inventor: Richard Healey, JUPITER, FL (US)

(21) Appl. No.: 17/690,640

(22) Filed: Mar. 9, 2022

Related U.S. Application Data
(60) Provisional application No. 63/160,487, filed on Mar. 12, 2021.

(51) Int. Cl. B27K 5/02; A47B 96/20; A47B 81/00

(52) U.S. Cl. CPC B27K 5/02; A47B 96/205; A47B 81/00; B27K 2240/70

(57) ABSTRACT

An outdoor cabinet is provided, including at least one carcass fabricated from an engineered wood, the carcass having walls and a waterproof facing on at least one of the walls. The cabinet includes at least one door fabricated from a thermoplastic polymer, where the door is attached to the carcass by at least one hinge. The engineered wood may be medium density fiberboard. The thermoplastic polymer may be high density polyethylene. The waterproof facing may be melamine.

### CROSS REFERENCE TO RELATED APPLICATION

This application claims priority to U.S. Provisional Patent Application No. 63/160,487, entitled Outdoor Cabinet, filed Mar. 12, 2021, pending.

### FIELD OF THE INVENTION

This invention relates generally to cabinets, and more particularly to a new and improved cabinet system for outdoor applications.

### BACKGROUND OF THE INVENTION

An outdoor cabinet in accordance with the present invention refers to a device which is made of metal or non-metallic material, exposed to the influence of the natural climate.

Conventional cabinets and cabinet systems have been in use for centuries and are well known. Conventional cabinets are widely used in both commercial and residential establishments and serve many purposes, both functional and aesthetic. For example, cabinets not only offer suitable storage space for items and objects, but cabinets may also be some of the more ornate fixtures in any homeowner's elaborate kitchen, bath, garage, or other similar space.

However, conventional cabinets are not designed nor constructed for outdoor applications. Conventional cabinets have been installed in outdoor locations, but they are not constructed to withstand the elements such as rain, snow, frost, direct sunlight and high humidity. Most significantly, conventional cabinets are susceptible to water damage, because the materials used to construct them are highly susceptible to liquid. For example, conventional cabinets are often constructed with plywood, particle board or chipboard, or medium-density fiberboard (“MDF”). Water damage in conventional cabinets often leads to panel expansion, delamination, failure of the joints and ultimately failure of the cabinet.

Accordingly, there is a need in the cabinetry market for a cabinet that solves the above-mentioned problems. Specifically, there is a need for a cabinet that is designed and constructed expressly for outdoor installation.

### SUMMARY OF THE INVENTION

The present invention is directed to an outdoor cabinet and includes at least one carcass fabricated from a waterproof engineered wood. The carcass has plurality of walls and a waterproof facing on at least one of the walls. The cabinet includes at least one door fabricated from a thermoplastic polymer. The door is attached to the carcass by at least one hinge. The engineered wood may be medium density fiberboard. The thermoplastic polymer may be high density polyethylene. The waterproof facing may be melamine.

The cabinet may include at least one decorative panel disposed on at least one wall of the carcass, where the decorative panel is fabricated from, for example, a thermoplastic polymer. The thermoplastic polymer may be a high-density polyethylene. The walls of the carcass may be stapled together, nailed together, doweled and glued together or any combination thereof.

The cabinet may have at least one shelf made of the melamine-faced waterproof medium density fiberboard composite. The cabinet may include at least one drawer made of the melamine-faced waterproof medium density fiberboard composite. A decorative panel may be attached to a wall of the drawer. The decorative panel may be fabricated from high density polyethylene material. The high-density polyethylene may be solid, marine-grade, high density polyethylene.

### BRIEF DESCRIPTION OF THE DRAWINGS

FIG. 1A is an isometric view of an outdoor cabinet in accordance with a first exemplary embodiment of the present invention, shown with its exterior door in an opened position.

FIG. 1B is an isometric view of the outdoor cabinet of FIG. 1A, shown with its exterior door in a closed position.

FIG. 2 is an isometric view of an outdoor cabinet in accordance with a second exemplary embodiment of the present invention, shown with its exterior doors in an open position.

FIG. 3 is an isometric view of an outdoor cabinet in accordance with a third exemplary embodiment of the present invention, shown with its doors and a drawer in open positions.

FIG. 4 is a cross sectional view of an exemplary composite material, shown with a decorative panel installed thereon for use in the outdoor cabinet of FIGS. 1-3.

### DETAILED DESCRIPTION

It should be understood that the phraseology and terminology used below for the purpose of description and should not be regarded as limiting. The use herein of the terms “comprising,” “including,” “having,” “containing,” and variations thereof are meant to encompass the structures and features recited thereafter and equivalents thereof as well as additional structures and features. Unless specified or limited otherwise, the terms “attached,” “mounted,” “affixed,” “connected,” “supported,” “coupled,” and variations thereof are used broadly and encompass both direct and indirect forms of the same.

The present invention is directed to a combination of the solid, marine-grade thermoplastic polymer, for example, high density polyethylene (HDPE), doors and decorative panels mounted on a waterproof carcass made from an engineered wood (for example, waterproof medium-density fiberboard (MDF)), having a waterproof facing (for example, a resin based facing such as melamine), to provide a cabinet box that performs like a wooden cabinet, thereby allowing an installation contractor to easily modify and connect plural cabinets together. The thermoplastic polymer (e.g., HDPE) doors and decorative panels are suited for direct exposure to the elements (e.g., sun, rain, snow, frost). The melamine-faced waterproof engineered wood (e.g., MDF) carcass of the cabinet of the present invention can be cut and drilled using standard wood blades and drill bits. It can also be stapled, nailed and glued therefore allowing the carcasses of the cabinets to be glued together, unlike prior art outdoor cabinets made entirely of HDPE, which cannot be glued together stapled and/or nailed and require the use of stainless-steel screws, which can be easily stripped out.

As used herein, the terms “cabinet box” and “carcass” are used interchangeably to refer to the main framework or body of a cabinet, not including any coverings, doors, front face panels (including frames for the front face panels) and nonstructural shelves.

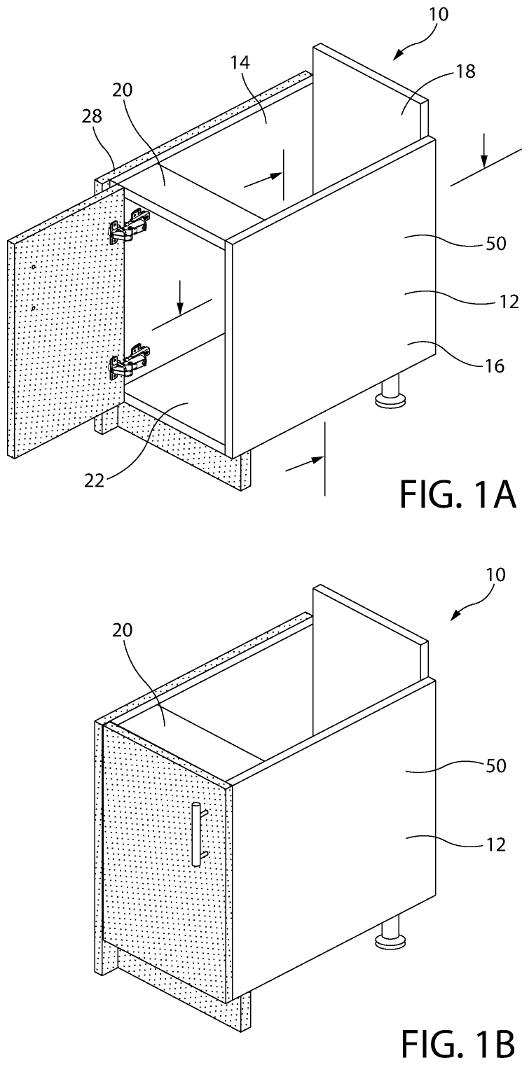

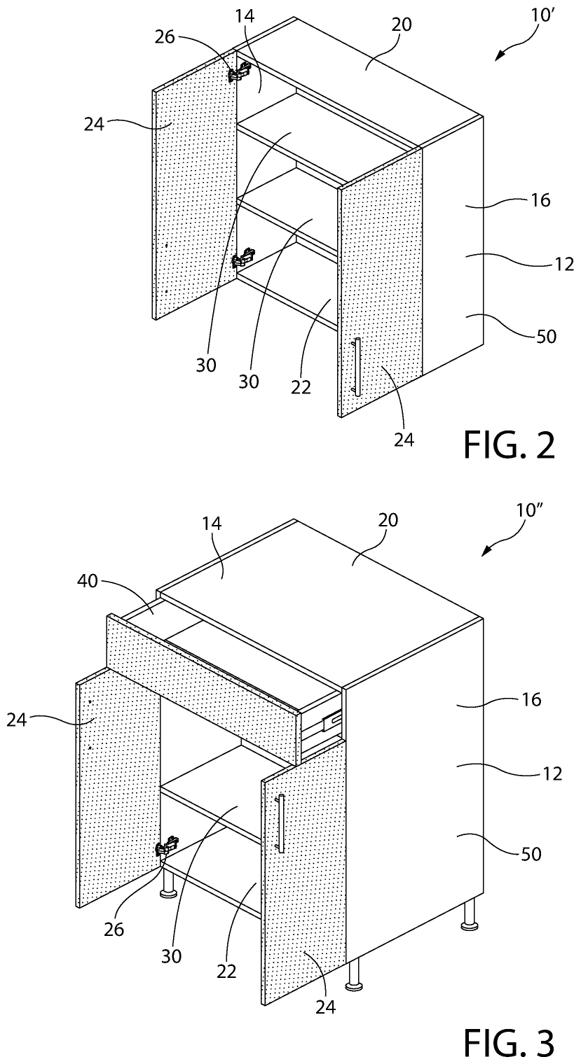

Referring now to the drawing figures wherein like reference numbers refer to like elements throughout the several views, there is shown in FIGS. 1A and 1B an outdoor cabinet 10 in accordance with a first exemplary embodiment of the present invention. The outdoor cabinet 10 comprises an open front, carcass 12, typically, but not exclusively, square or rectangular, having opposing side walls 14 and 16, a back wall 18, and opposing top and bottom walls 20 and 22 extending between the side walls 14 and 16 at a top and a bottom of the carcass 12. In the embodiment illustrated in FIGS. 1A and 1B, the top wall 20 partially closes the top of the carcass 12. Such an embodiment of the cabinet 10 can be used in installations where a separate counter top (not shown) is installed over the outdoor cabinet 10. In other embodiments of the outdoor cabinet 10′, 10″, as illustrated in FIGS. 2 and 3, the top walls 20′, 20″ can fully enclose the top of the carcass 12′, 12″. In other embodiments, the back wall can be omitted so that the back of the outdoor cabinet is open (not shown).

As illustrated in FIGS. 2 and 3, the outdoor cabinet 10′, 10″ can include one or more shelves 30′, 30″. In addition, as illustrated in FIG. 3, the outdoor cabinet 10″ can include one or more drawers 40″. For simplicity, reference numbers of the outdoor cabinets 10, 10′ and 10′″ utilize like reference numbers for substantially similar parts and are not separately discussed for each exemplary embodiment.

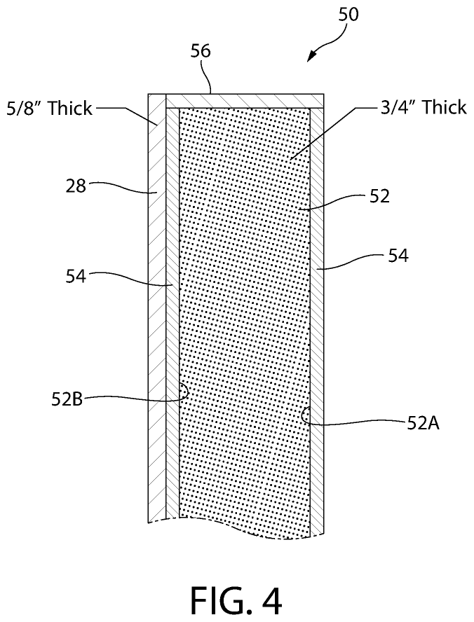

The side walls 14 and 16, back wall 18, top wall 20, and bottom wall 22 of the carcass 12 are constructed from a melamine-faced waterproof engineered wood (e.g., waterproof medium density fiberboard (MDF)) composite material 50. An example of such a waterproof, engineered wood composite material is sold under the tradename, All-Weatherboard® sold by Weatherstrong, an Ideal Cabinetry Company. As can be seen in FIG. 4, the composite material 50 comprises engineered wood 52, for example, MDF, preferably made of hardwood and/or softwood fibers, which have been combined with a wax and a resin binder and formed into a panel by applying high temperature and pressure. In some embodiments, the engineered wood 52 (e.g., waterproof MDF) can be ¾ of an inch thick. Panels of the engineered wood 52 can be purchased from, for example, Jeld-Wen, Inc. under the product name is Extira®.

The melamine facing 54 of the composite material 50 of an exemplary embodiment of the present invention is a thermo-fused low pressure laminate skin. More specifically, the melamine facing 54 may comprise a decorative paper impregnated with a resin. The melamine is laminated onto the side surfaces of the engineered wood 52 using a low-pressure lamination process. In this process, the resin impregnated decorative paper is pressed onto the side surfaces 52A, 52B of the engineered wood 52 under extreme heat and pressure using a press plate. The heat activates the resin in the decorative paper, which fuses the paper to the side surfaces of the MDF panel to create the composite material 50. Therefore, the resulting melamine facing essentially becomes part of the MDF panel. The texture of the press plate is transferred to the melamine facing to provide the melamine facing and therefore, the MDF panel, with a certain finish. This finish can include, for example, a matte, gloss, stipple, or woodgrain finish. The edges of the MDF panel can be sealed with a waterproof PVC banding 56.

The composite material 50 of the carcass 12 can be assembled together to form the carcass using a conventional wood dowel and a glue system, with the addition of stainless steel staples.

The shelves 30 (FIGS. 2 and 3) and the drawers 40 (FIG. 3) can also be made of the melamine-faced, waterproof medium density fiberboard (MDF) composite material 50.

As illustrated in FIGS. 1A, 1B, 2 and 3, the cabinet 10, 10′, 10″ may further include one or more doors 24 made of, for example, solid, marine-grade, high density polyethylene (HDPE) material. The solid HDPE door(s) 24 is/are hinged to the carcass 12 with one or more stainless steel conventional hinges 26 (e.g., soft-close adjustable stainless-steel hinges).

Any of walls 14, 16, 18, 20, 22 of the carcass 12 and/or front wall(s) (not visible) of the drawer(s) 40 that are to be exposed to the external environment, may be covered with a decorative panel 28 made of, for example, the solid, marine-grade, HDPE material that is attached to the corresponding wall 14, 16, 18, 20 of the carcass 12. The decorative HDPE panels 28 can be attached to the walls 14, 16, 18, 20 of the carcass 12 with conventional fasteners, such as stainless-steel screws or a construction adhesive such as Liquid Nails®. For example, as illustrated in the embodiment of the cabinet 10 shown in FIGS. 1A and 1B, the side wall 14 of the carcass is covered by a solid HDPE decorative panel 28 while the side wall 16, back wall 18, top wall 20, and bottom wall 22 of the carcass 12 are not. Such an embodiment can be used in an installation where the carcass 12 of the cabinet 10 is connected to the carcass of another cabinet and where the back wall 18 of the cabinet 10 is positioned against or mounted to or on another surface, such as a wall of a house. In such installation, only the external environmentally exposed wall 14 of the carcass would be covered with the decorative panel 28 made of the solid HDPE material.

The drawer 40 of the embodiment of the cabinet 10 illustrated in FIG. 3, comprises a front wall (not visible) that may be covered with a decorative panel 28 made of, for example, the solid, marine-grade, HDPE material.

In some embodiments, the solid, marine-grade, HDPE doors 24 and decorative panels 28 can be ⅝″ thick. The solid, marine-grade, HDPE doors 24 and decorative panels 28 can be routed with different decorative patterns and finishes (solid colors or woodgrain colors; not shown).

A plurality of the outdoor cabinets 10, 10′, 10″ can be assembled together to build an outdoor kitchen or an indoor kitchen.

As noted, the combination of the solid, marine-grade HDPE doors 24 (and decorative panels 28) mounted on a melamine-faced waterproof MDF carcass 12 provides a cabinet box that performs like a wooden cabinet, thereby allowing an installation contractor to easily modify and connect plural cabinets 10, 10′, 10″ together, while the HDPE doors 24 (and decorative panels 28) are suited for direct exposure to the elements (sun, rain, snow, frost). In particular, the melamine-faced waterproof MDF carcass 12 of the cabinet 10, 10′, 10″ of the present disclosure can be cut and drilled using standard wood blades and drill bits. It can also be stapled, nailed and glued therefore allowing the carcasses of the cabinets to be glued together, unlike prior art outdoor cabinets made entirely of HDPE, which cannot be glued together stapled and/or nailed and require the use of stainless-steel screws, which can be easily stripped out. Although HDPE can be cut and drilled HDPE with wood blades and drill bits, such cutting and drilling requires extra care.

It should be understood that the invention is not limited to the embodiments illustrated and described herein. Rather, the appended claims should be construed broadly to include other variants and embodiments of the invention, which may be made by those skilled in the art without departing from the scope and range of equivalents of the invention. It is indeed intended that the scope of the invention should be determined by proper interpretation and construction of the appended claims and their legal equivalents, as understood by those of skill in the art relying upon the disclosure in this specification and the attached drawings.

What is claimed is:

1. A cabinet, comprising:
(a) at least one carcass fabricated from a waterproof engineered wood, the carcass comprising a plurality of walls and a waterproof facing on at least one of the walls; and
(b) at least one door fabricated from a thermoplastic polymer, the door attached to the carcass by at least one hinge.

2. The cabinet of claim 1, wherein the engineered wood is medium density fiberboard.

3. The cabinet of claim 1, wherein the thermoplastic polymer is high density polyethylene

4. The cabinet of claim 1, further comprising at least one decorative panel disposed on at least one wall of the carcass, the at least one decorative panel fabricated from a thermoplastic polymer.

5. The cabinet of claim 4, wherein the thermoplastic polymer is a high-density polyethylene.

6. The cabinet of claim 1, wherein the waterproof facing is melamine.

7. The cabinet of claim 1, wherein the walls of the carcass are stapled together.

8. The cabinet of claim 1, wherein the walls of the carcass are nailed together.

9. The cabinet of claim 1, wherein the walls of the carcass are glued together.

10. The cabinet of claim 1, wherein the walls of the carcass are stapled and nailed together.

11. The cabinet of claim 1, wherein the walls of the carcass are stapled and glued together.

12. The cabinet of claim 1, wherein the walls of the carcass are nailed and glued together.

13. The cabinet of claim 1, further comprising at least one shelf made of the melamine-faced waterproof medium density fiberboard composite.

14. The cabinet of claim 1, further comprising at least one drawer made of the melamine-faced waterproof medium density fiberboard composite.

15. The cabinet of claim 12, further comprising a decorative panel attached to a wall of the drawer.

16. The cabinet of claim 13, wherein the decorative panel is fabricated from high density polyethylene material.

17. The cabinet of claim 1, wherein the high-density polyethylene comprises solid, marine-grade, high density polyethylene.
